(19) United States
(12) Patent Application Publication
(10) Pub. No.: US 2019/0281562 A1
(43) Pub. Date: Sep. 12, 2019

(54) POWER HEADROOM REPORT REPORTING METHOD AND APPARATUS

(71) Applicant: HUAWEI TECHNOLOGIES CO., LTD., Shenzhen (CN)

(72) Inventors: Guorong LI, Shenzhen (CN); Lili ZHANG, Beijing (CN)

(21) Appl. No.: 16/345,244

(22) PCT Filed: Mar. 31, 2017
(86) PCT No.: PCT/CN2017/079135

§ 371 Date: Apr. 26, 2019

(30) Foreign Application Priority Data
Nov. 15, 2016 (CN) 201611022454.4

(51) Int. Cl. H04W 52/36; H04W 52/34

(52) U.S. Cl. CPC H04W 52/365; H04W 76/27; H04W 52/346

(57) ABSTRACT

Embodiments of the present invention provide a power headroom report reporting method and an apparatus. The power headroom report reporting method in the present invention includes: receiving, by user equipment, power headroom report PHR level information sent by a base station; determining, by the user equipment based on the PHR level information, a PHR corresponding to the PHR level information; and sending, by the user equipment, the PHR corresponding to the PHR level information to the base station. In the embodiments of the present invention, the base station can obtain PH of the UE at a corresponding level based on a scheduling requirement, and further perform proper scheduling on the UE based on a PHR.

### TECHNICAL FIELD

This application relates to communications technologies, and in particular, to a power headroom report reporting method and an apparatus.

### BACKGROUND

To help a scheduler select a modulation and coding scheme (Modulation and Coding Scheme, MCS) and a resource size M that do not cause power limitation of user equipment (User Equipment, UE), the UE may be configured to periodically provide a power headroom report (Power Headroom Report, PHR) on power usage of the UE. This is a process in which the UE reports power headroom (Power Headroom, PH) to a network side.

LTE Release 10 defines two different types of power headroom reports: type 1 and type 2. Reported PH of the type 1 is PH that is based on an assumption that there is only PUSCH transmission in a serving cell. Reported PH of the type 2 is PH that is based on an assumption that there is a combination of PUSCH transmission and PUCCH transmission in a serving cell.

If the power headroom (PH) of the type 1 is valid to a specific subframe, assuming that the UE has real scheduled PUSCH transmission in the subframe, a calculation expression is as follows:

PH=P_{CMAX,c}−(P_{0,PUSCH}+αPL_{DL}+10·log₁₀(M)+ΔMCS+δ)

P_{CMAX,c} is maximum transmit power of the UE in a serving cell, M is a size of a resource used in a subframe corresponding to a PHR, and ΔMCS is a modulation and coding scheme used in the subframe corresponding to the PHR.

It can be learned from the PH calculation formula that PH is a difference between P_{CMAX,c} and (P_{0,PUSCH}+αPL_{DL}+10·log₁₀(M)+ΔMCS+δ) However, (P_{0,PUSCH}+αP_{LD}+10·log₁₀ (M)+ΔMCS+δ) has no upper limit. Therefore, PH calculated by using the foregoing formula may be a negative value. Similar to the type 1, the power headroom report of the type 2 is defined as a difference obtained by subtracting a sum of PUSCH transmit power and PUCCH transmit power from maximum transmit power of each serving cell, and the sum of PUSCH transmit power and PUCCH transmit power is also a value that has no upper limit. Therefore, PH may also be a negative value. If PH is a negative value, it indicates that the network side schedules a higher data rate beyond support by available transmit power of the UE.

However, with continuous development of communications technologies, high-band networking and ultra dense networking are widely applied. For the ultra dense networking, one fifth-generation NodeB (gNB) may be corresponding to one or more transmission and reception points (Transmission and Reception Point, TRP). Therefore, each new radio (New Radio, NR) cell may also be corresponding to one or more TRPs. When one cell is corresponding to a plurality of TRPs, these TRPs form a TRP group, that is, a TRPG and one cell may include one TRPG For the high-band networking, beams (beam) formed in different directions can cover a service area, and an area of each TRP can be covered by a plurality of narrow high-gain beams. However, calculation and reporting of the foregoing PH mechanism are specific to each serving cell (that is, a component carrier), including a primary component carrier PCell or an optional secondary component carrier SCell. The calculation and reporting of the foregoing HR mechanism cannot meet a PHR requirement in scenarios of the high-band networking and the ultra dense networking, and therefore uplink data fails to be sent due to UE limitation.

### SUMMARY

Embodiments of the present invention provide a power headroom report reporting method and an apparatus, so that a base station obtains PH of UE at a corresponding level based on a scheduling requirement, and further performs proper scheduling on the UE based on a PHR.

According to a first aspect, an embodiment of the present invention provides a power headroom report reporting method, including:

receiving, by user equipment, power headroom report PHR level information sent by a base station;

determining, by the user equipment based on the PHR level information, a PHR corresponding to the PHR level information; and

sending, by the user equipment, the PHR corresponding to the PHR level information to the base station.

With reference to the first aspect, in a possible implementation of the first aspect, the PHR level information includes any one or a combination of transmission and reception point group TRPG level information, transmission and reception point TRP level information, beam level information, and base station level information; and

the determining, by the user equipment based on the PHR level information, a PHR corresponding to the PHR level information includes:

determining, by the user equipment based on the PHR level information, a PHR corresponding to each piece of level information.

In this implementation, the base station sends the power headroom report PHR level information to the user equipment, the user equipment determines, based on the PHR level information, the PHR corresponding to the PHR level information, and the user equipment sends the PHR corresponding to the PHR level information to the base station. In this way, the base station obtains PH of the UE at a corresponding level based on a scheduling requirement, and further performs proper scheduling on the UE based on a PHR.

With reference to the first aspect or the possible implementation of the first aspect, in another possible implementation of the first aspect, if the PHR level information includes the TRPG level information, the determining, by the user equipment based on the PHR level information, a PHR corresponding to each piece of level information includes:

determining, by the user equipment based on the TRPG level information, maximum transmit power allowed by the user equipment for at least one TRPG;

separately determining, by the user equipment based on the maximum transmit power allowed for the at least one TRPG and uplink transmit power from the user equipment to each TRPG PH corresponding to each TRPG; and

generating, by the user equipment based on the PH corresponding to each TRPG a PHR corresponding to the TRPG level information; where

the uplink transmit power from the user equipment to each TRPG is a sum of uplink transmit power of the user equipment at all TRPs included in each TRPG

In this implementation, the base station can obtain PH of the UE at a TRPG level based on a scheduling requirement, and further perform proper scheduling on the UE based on a PHR.

With reference to the first aspect or either of the foregoing possible implementations of the first aspect, in another possible implementation of the first aspect, the sending, by the user equipment, the PHR corresponding to the PHR level information to the base station includes:

sending, by the user equipment, the PHR corresponding to the TRPG level information to the base station, where

the PHR corresponding to the TRPG level information includes an index of the at least one TRPG and PH corresponding to an index of each TRPG

In this implementation, the base station can obtain PH of the UE at a TRPG level based on a scheduling requirement, and further perform proper scheduling on the UE based on a PHR.

With reference to the first aspect or any one of the foregoing possible implementations of the first aspect, in another possible implementation of the first aspect, if the PHR level information includes the TRP level information, the determining, by the user equipment based on the PHR level information, a PHR corresponding to each piece of level information includes:

determining, by the user equipment based on the TRP level information, maximum transmit power allowed by the user equipment for at least one TRP;

separately determining, by the user equipment based on the maximum transmit power allowed for the at least one TRP and uplink transmit power from the user equipment to each TRP, PH corresponding to each TRP; and

generating, by the user equipment based on the PH corresponding to each TRP, a PHR corresponding to the TRP level information; where

the uplink transmit power from the user equipment to each TRP is a sum of uplink transmit power of the user equipment on all beams included in each TRP.

In this implementation, the base station can obtain PH of the UE at a TRP level based on a scheduling requirement, and further perform proper scheduling on the UE based on a PHR.

With reference to the first aspect or any one of the foregoing possible implementations of the first aspect, in another possible implementation of the first aspect, the sending, by the user equipment, the PHR corresponding to the PHR level information to the base station includes:

sending, by the user equipment, the PHR corresponding to the TRP level information to the base station, where

the PHR corresponding to the TRP level information includes PH corresponding to the at least one TRP.

In this implementation, the base station can obtain PH of the UE at a TRP level based on a scheduling requirement, and further perform proper scheduling on the UE based on a PHR.

With reference to the first aspect or any one of the foregoing possible implementations of the first aspect, in another possible implementation of the first aspect, if the PHR level information includes the beam level information, the determining, by the user equipment based on the PHR level information, a PHR corresponding to each piece of level information includes:

determining, by the user equipment based on the beam level information, maximum transmit power allowed by the user equipment for at least one beam;

separately determining, by the user equipment based on the maximum transmit power allowed for the at least one beam and uplink transmit power of the user equipment on each beam, PH corresponding to each beam; and

generating, by the user equipment based on the PH corresponding to each beam, a PHR corresponding to the beam level information.

In this implementation, the base station can obtain PH of the UE at a beam level based on a scheduling requirement, and further perform proper scheduling on the UE based on a PHR.

With reference to the first aspect or any one of the foregoing possible implementations of the first aspect, in another possible implementation of the first aspect, the sending, by the user equipment, the PHR corresponding to the PHR level information to the base station includes:

the sending, by the user equipment, the PHR corresponding to the PHR level information to the base station includes:

the PHR corresponding to the beam level information includes PH corresponding to the at least one beam.

In this implementation, the base station can obtain PH of the UE at a beam level based on a scheduling requirement, and further perform proper scheduling on the UE based on a PHR.

With reference to the first aspect or any one of the foregoing possible implementations of the first aspect, in another possible implementation of the first aspect, if the PHR level information includes the base station level information, the determining, by the user equipment based on the PHR level information, a PHR corresponding to each piece of level information includes:

determining, by the user equipment based on the base station level information, maximum transmit power allowed by the user equipment for at least one base station;

separately determining, by the user equipment based on the maximum transmit power allowed for the at least one base station and uplink transmit power from the user equipment to each base station, PH corresponding to each base station; and

generating, by the user equipment based on the PH corresponding to each base station, a PHR corresponding to the base station level information; where

the uplink transmit power from the user equipment to each base station is a sum of uplink transmit power of the user equipment in all cells included in each base station.

In this implementation, the base station can obtain PH of the UE at a base station level based on a scheduling requirement, and further perform proper scheduling on the UE based on a PHR.

With reference to the first aspect or any one of the foregoing possible implementations of the first aspect, in another possible implementation of the first aspect, the sending, by the user equipment, the PHR corresponding to the PHR level information to the base station includes:

sending, by the user equipment, a PHR corresponding to the base station level information to the base station, where

the PHR corresponding to the base station level information includes an index of the at least one base station and PH corresponding to an index of each base station.

In this implementation, the base station can obtain PH of the UE at a base station level based on a scheduling requirement, and further perform proper scheduling on the UE based on a PHR.

According to a second aspect, an embodiment of the present invention provides a power headroom report reporting method, including:

sending, by a base station, power headroom report PHR level information to user equipment, where the PHR level information is used to instruct the user equipment to determine, based on the PHR level information, a PHR corresponding to the PHR level information; and

receiving, by the base station, the PHR that is corresponding to the PHR level information and that is sent by the user equipment.

In this implementation, the base station sends the power headroom report PHR level information to the user equipment, the user equipment determines, based on the PHR level information, the PHR corresponding to the PHR level information, and the user equipment sends the PHR corresponding to the PHR level information to the base station. In this way, the base station obtains PH of the UE at a corresponding level based on a scheduling requirement, and further performs proper scheduling on the UE based on a PHR.

With reference to the second aspect, in a possible implementation of the second aspect, the PHR level information includes any one or a combination of transmission and reception point group TRPG level information, transmission and reception point TRP level information, beam level information, and base station level information; and

the receiving, by the base station, the PHR that is corresponding to the PHR level information and that is sent by the user equipment includes: receiving, by the base station, a PHR that is corresponding to each piece of level information and that is sent by the user equipment.

With reference to the second aspect or the possible implementation of the second aspect, in another possible implementation of the second aspect, the sending, by a base station, power headroom report PHR level information to user equipment includes:

sending, by the base station, radio resource control signaling to the user equipment, where the radio resource control signaling includes the PHR level information; or

sending, by the base station, a Media Access Control MAC control information element to the user equipment, where the MAC control information element includes the PHR level information.

According to a third aspect, an embodiment of the present invention provides user equipment, and the user equipment has a function of implementing behavior of the user equipment in the foregoing method embodiment. The function may be implemented by using hardware, or may be implemented by executing corresponding software by hardware. The hardware or software includes one or more modules corresponding to the foregoing function.

According to a fourth aspect, an embodiment of the present invention provides user equipment, including: a processor, a memory, a bus, and a communications interface, where the memory is configured to store a computer executable instruction, the processor and the memory are connected by using the bus, and when the user equipment runs, the processor executes the computer executable instruction stored in the memory, so that the user equipment performs the power headroom report reporting method according to any implementation of the first aspect.

According to a fifth aspect, an embodiment of the present invention provides a computer readable storage medium, configured to store a computer software instruction used by the foregoing user equipment, and when the computer software instruction runs on a computer, the computer can perform the power headroom report reporting method according to any implementation of the first aspect.

According to a sixth aspect, an embodiment of the present invention provides a computer program product that includes an instruction. When the computer program product runs on a computer, the computer can perform the power headroom report reporting method according to any implementation of the first aspect.

In addition, for technical effects brought by any one of the design manners in the third aspect to the sixth aspect, refer to the technical effects brought by the different design manners in the first aspect. Details are not provided herein.

According to a seventh aspect, an embodiment of the present invention provides a base station, where the base station has a function of implementing behavior of the base station in the foregoing method embodiment. The function may be implemented by using hardware, or may be implemented by executing corresponding software by hardware. The hardware or software includes one or more modules corresponding to the foregoing function.

According to an eighth aspect, an embodiment of the present invention provides a base station, including: a processor, a memory, a bus, and a communications interface, where the memory is configured to store a computer executable instruction, the processor and the memory are connected by using the bus, and when the base station runs, the processor executes the computer executable instruction stored in the memory, so that the base station performs the power headroom report reporting method according to any implementation of the second aspect.

According to a ninth aspect, an embodiment of the present invention provides a computer readable storage medium, configured to store a computer software instruction used by the foregoing base station, and when the computer software instruction runs on a computer, the computer can perform the power headroom report reporting method according to any implementation of the second aspect.

According to a tenth aspect, an embodiment of the present invention provides a computer program product that includes an instruction. When the computer program product runs on a computer, the computer can perform the power headroom report reporting method according to any implementation of the second aspect.

In addition, for technical effects brought by any one of the design manners in the seventh aspect to the tenth aspect, refer to the technical effects brought by the different design manners in the second aspect. Details are not provided herein.

According to the power headroom report reporting method and the apparatus in the embodiments of the present invention, the base station sends the power headroom report PHR level information to the user equipment, the user equipment determines, based on the PHR level information, the PHR corresponding to the PHR level information, and the user equipment sends the PHR corresponding to the PHR level information to the base station. In this way, the base station obtains PH of the UE at a corresponding level based on a scheduling requirement, and further performs proper scheduling on the UE based on a PHR.

### BRIEF DESCRIPTION OF DRAWINGS

To describe the technical solutions in the embodiments of the present invention or in the prior art more clearly, the following briefly describes the accompanying drawings required for describing the embodiments or the prior art.

FIG. 1 is a schematic diagram of an application scenario according to an embodiment of the present invention;

FIG. 2 is a flowchart of a power headroom report reporting method according to an embodiment of the present invention;

FIG. 3 is a flowchart of another power headroom report reporting method according to an embodiment of the present invention;

FIG. 4A is a flowchart of another power headroom report reporting method according to an embodiment of the present invention;

FIG. 4B is a schematic diagram of a format of a MAC CE used by a PHR corresponding to TRP level information according to an embodiment of the present invention;

FIG. 4C is a schematic diagram of another format of a MAC CE used by a PHR corresponding to TRP level information according to an embodiment of the present invention;

FIG. 4D is a schematic diagram of still another format of a MAC CE used by a PHR corresponding to TRP level information according to an embodiment of the present invention;

FIG. 5A is a flowchart of another power headroom report reporting method according to an embodiment of the present invention;

FIG. 5B is a schematic diagram of a format of a MAC CE used by a PHR corresponding to beam level information according to an embodiment of the present invention;

FIG. 5C is a schematic diagram of another format of a MAC CE used by a PHR corresponding to beam level information according to an embodiment of the present invention;

FIG. 5D is a schematic diagram of still another format of a MAC CE used by a PHR corresponding to beam level information according to an embodiment of the present invention;

FIG. 6A is a flowchart of another power headroom report reporting method according to an embodiment of the present invention;

FIG. 6B is a schematic diagram of a format of a MAC CE used by a PHR corresponding to base station level information according to an embodiment of the present invention;

FIG. 6C is a schematic diagram of another format of a MAC CE used by a PHR corresponding to base station level information according to an embodiment of the present invention;

FIG. 7 is a schematic structural diagram of user equipment according to an embodiment of the present invention; and

FIG. 8 is a schematic structural diagram of a base station according to an embodiment of the present invention.

### DESCRIPTION OF EMBODIMENTS

To make the purpose, technical solutions, and advantages of the embodiments of the present invention clearer, the following clearly and completely describes the technical solutions of the embodiments of the present invention with reference to the accompanying drawings in the embodiments of the present invention.

User equipment (User Equipment, UE) in this specification may represent any applicable end user equipment, and may include (or may represent) devices such as a wireless transmit/receive unit (wireless transmit/receive unit, WTRU), a mobile station, a mobile node, a mobile device, a fixed or mobile subscription unit, a pager, a mobile phone, a personal digital assistant (personal digital assistant, PDA), a smartphone, a notebook computer, a computer, a touchscreen device, a wireless sensor, or a consumer digital device. The “mobile” station/node/device herein represents a station/node/device connected to a wireless (or mobile) network and does not necessarily relate to actual mobility of the station/node/device.

“Multiple” in this specification means two or more. The term “and/or” describes an association relationship for describing associated objects and represents that three relationships may exist. For example, A and/or B may represent the following three cases: Only A exists, both A and B exist, and only B exists. The character “/” generally indicates an “or” relationship between the associated objects.

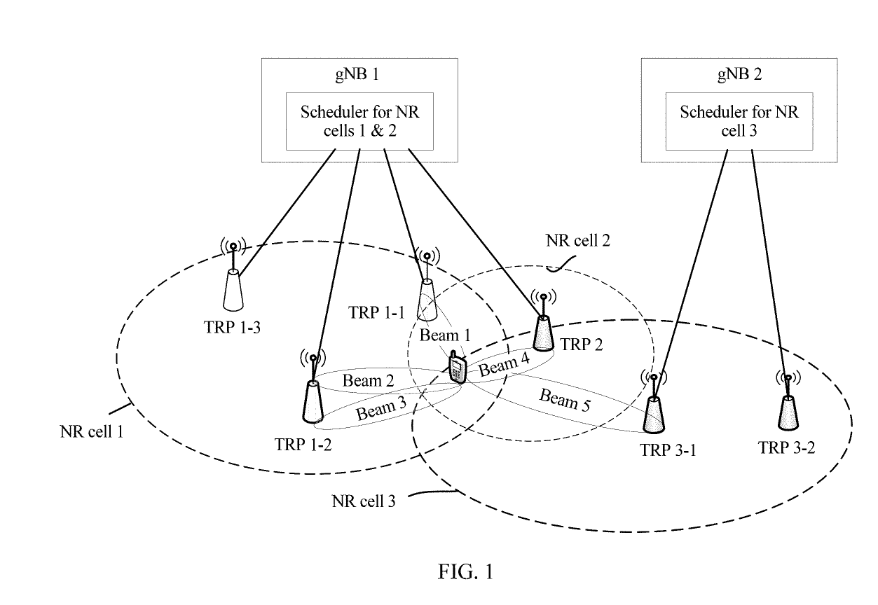

FIG. 1 is a schematic diagram of an application scenario according to an embodiment of the present invention. As shown in FIG. 1, a new radio (New Radio, NR for short) cell may include one or more TRPs, where a plurality of TRPs may correspond to one TRPGS the cell may include one TRPGS and UE may send uplink data by using a plurality of TRPs. A frequency band used by a TRP may be a low frequency or may be a high frequency. When the TRP is deployed in a high frequency manner, a beamforming (beamforming) technology may be used to resist vulnerability of a high frequency link. An area of each TRP may be covered by a plurality of narrow high-gain beams (beams), and each TRP may communicate with UE by using one or more beams (beams). The application scenario shown in FIG. 1 is used as an example for description. Three NR cells are respectively an NR cell 1, an NR cell 2, and an NR cell 3. A gNB 1 includes a scheduler (scheduler) for NR cells 1 & 2, the scheduler for the NR cells 1 & 2 establishes a communication connection to a TRP in the NR cell 1 and a TRP in the NR cell 2, the NR cell 1 includes a TRP 1-1, a TRP 1-2, and a TRP 1-3, and the NR cell 2 includes a TRP 2. A gNB 2 includes a scheduler (scheduler) for an NR cell 3, the scheduler for the NR cell 3 establishes a communication connection to a TRP in the NR cell 3, and the NR cell 3 includes a TRP 3-1 and a TRP 3-2.

To meet a PHR requirement in scenarios of high-band networking and/or ultra dense networking, an embodiment of the present invention provides a power headroom report reporting method. A PHR level of UE is configured by using a base station, and the UE performs PH calculation and reporting based on the configuration. In this way, the base station obtains PH of the UE at a corresponding level based on a scheduling requirement, and further performs proper scheduling on the UE based on a PHR. The following uses several specific embodiments to describe in detail the power headroom report reporting method in this embodiment of the present invention.

It should be noted that a base station and a scheduler in this specification may be replaced with each other to perform the following method embodiments of the embodiments of the present invention. The base station is the gNB 1 or the gNB 2 shown in FIG. 1. The scheduler is the scheduler (scheduler) for the NR cells 1 & 2 or the scheduler (scheduler) for the NR cell 3 shown in FIG. 1.

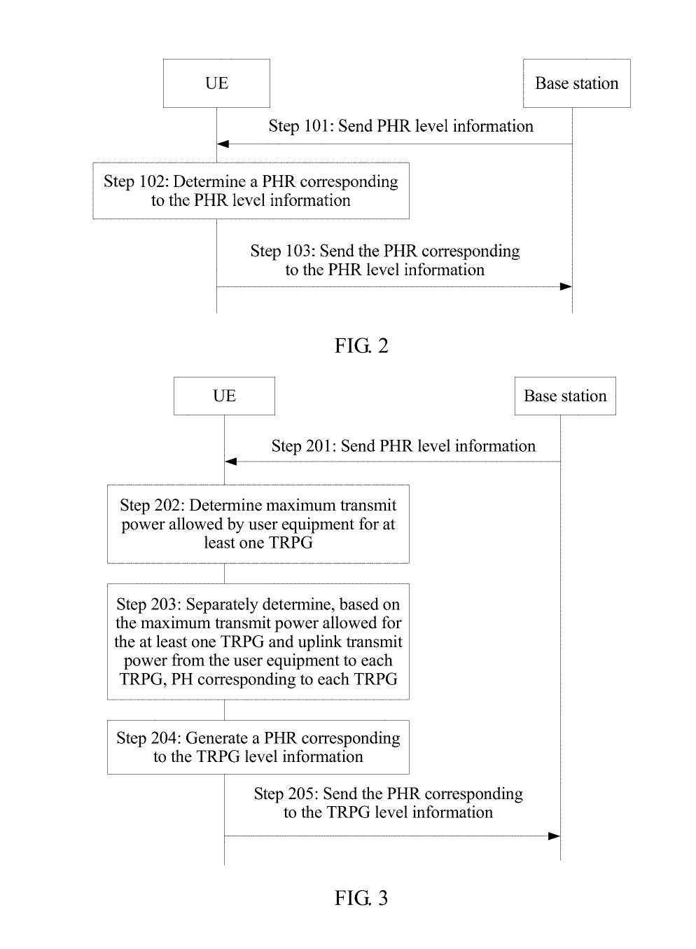

FIG. 2 is a flowchart of a power headroom report reporting method according to an embodiment of the present invention. As shown in FIG. 2, the method in this embodiment may include the following steps.

Step 101: A base station sends power headroom report PHR level information to user equipment.

The user equipment receives the PHR level information sent by the base station.

The PHR level information is used to instruct the user equipment to determine, based on the PHR level information, a PHR corresponding to the PHR level information. For example, the PHR level information may include any one or a combination of TRPG level information, TRP level information, beam level information, and base station level information. It may be understood that, with continuous development of communications networks, the PHR level information may further include other level information. The PHR level information in this embodiment of the present invention is not limited by the foregoing level information. Specifically, the base station may send the PHR level information to the user equipment by using a signaling message.

Step 102: The user equipment determines, based on the PHR level information, a PHR corresponding to the PHR level information.

Specifically, when the PHR level information in step 101 includes any one of the TRPG level information, the TRP level information, the beam level information, and the base station level information, the user equipment may determine, based on the PHR level information, PH corresponding to the PHR level information, and generate, based on the PH, the PHR corresponding to the PHR level information. When the PHR level information in step 101 includes a plurality of pieces of the TRPG level information, the TRP level information, the beam level information, and the base station level information, the user equipment may separately determine, based on the plurality of pieces of PHR level information, PH corresponding to each piece of PHR level information, and generate, based on the PH corresponding to each piece of PHR level information, a PHR corresponding to each piece of PHR level information, that is, the user equipment may determine, based on the PHR level information, a PHR corresponding to each piece of level information. The user equipment reports a combination of the PHRs corresponding to the plurality of pieces of PHR level information and a cell-level PHR. Certainly, it may be understood that the reporting may be separately performed.

Step 103: The user equipment sends the PHR corresponding to the PHR level information to the base station.

The base station receives the PHR that is corresponding to the PHR level information and that is sent by the user equipment.

Optionally, a specific implementation of step 101 is: the base station sends radio resource control (Radio Resource Control, RRC) signaling to the user equipment, where the radio resource control signaling may include the PHR level information.

Optionally, another specific implementation of step 101 is: the base station sends a Media Access Control (Media Access Control, MAC) control information element to the user equipment, where the MAC control information element may include the PHR level information.

In this embodiment, the base station sends the power headroom report PHR level information to the user equipment, the user equipment determines, based on the PHR level information, the PHR corresponding to the PHR level information, and the user equipment sends the PHR corresponding to the PHR level information to the base station. In this way, the base station obtains PH of the UE at a corresponding level based on a scheduling requirement, and further performs proper scheduling on the UE based on a PHR.

The following uses several specific embodiments to describe in detail the technical solutions of the method embodiment shown in FIG. 2.

FIG. 3 is a flowchart of another power headroom report reporting method according to an embodiment of the present invention. In this embodiment, a power headroom report reporting method in which PHR level information includes TRPG level information is specifically described. As shown in FIG. 3, the method in this embodiment may include the following steps.

Step 201: A base station sends power headroom report PHR level information to user equipment.

The user equipment receives the PHR level information sent by the base station.

For specific description of step 201, refer to step 101. When the PHR level information includes the TRPG level information, the following step 202 to step 205 may be performed.

Step 202: The user equipment determines, based on the TRPG level information, maximum transmit power allowed by the user equipment for at least one TRPG

Specifically, when the PHR level information includes the TRPG level information, the user equipment determines the maximum transmit power allowed by the user equipment for one or more TRPGs. The application scenario shown in FIG. 1 is further used as an example for description. The user equipment shown in FIG. 1 may send uplink data by using a TRP 1-1, a TRP 1-2, a TRP 2, and a TRP 3-1, where the TRP 1-1 and the TRP 1-2 belong to a TRPG 1, the TRP 2 belongs to a TRPG 2, and the TRP 3-1 belongs to a TRPG 3, and the user equipment determines, based on the TRPG level information, maximum transmit power P_{cmax,TRPG1} allowed by the user equipment for the TRPG 1, maximum transmit power P_{cmax,TRPG2} allowed by the user equipment for the TRPG 2, and maximum transmit power P_{cmax,TRPG3} allowed by the user equipment for the TRPG 3.

The user equipment may further determine uplink transmit power from the user equipment to each TRPG based on the TRPG level information. Specifically, the application scenario shown in FIG. 1 is further used as an example for description. The user equipment determines uplink transmit power from the user equipment to the TRPG 1, uplink transmit power from the user equipment to the TRPG 2, and uplink transmit power from the user equipment to the TRPG 3.

Step 203: The user equipment separately determines, based on the maximum transmit power allowed for the at least one TRPG and uplink transmit power from the user equipment to each TRPG PH corresponding to each TRPG

The uplink transmit power from the user equipment to each TRPG is a sum of uplink transmit power of the user equipment at all TRPs included in each TRPG and the uplink transmit power of the user equipment at each TRP is a sum of uplink transmit power of the user equipment on all beams in each TRP.

A specific implementation of step 203 is that the user equipment determines the PH corresponding to each TRPG in the following manner:

PH_{TPGi}=P_{cmax,TRPGi}−Uplink transmit power from UE to a TRPGi

In the foregoing formula, i is a positive integer, for example, P_{cmax,TRPGi} may be P_{cmax,TRPG1}, P_{cmax,TRPG2}, P_{cmax,TRPG3}, or the like. The uplink transmit power from the UE to TRPGi in the foregoing formula specifically means a sum of transmit power of the UE on all beams in all TRPs in TRPGi in a PHR reporting subframe. The TRPG 1 shown in FIG. 1 is used as an example for description. The uplink transmit power from the UE to the TRPG 1 is a sum of transmit power of the UE on a beam 1, a beam 2, and a beam 3. PH_{TPG1} is equal to P_{cmax,TRPG1} of the UE in the subframe minus the sum of transmit power of the UE on the beam 1, the beam 2, and the beam 3.

Step 204: The user equipment generates, based on the PH corresponding to each TRPG a PHR corresponding to the TRPG level information.

The PHR corresponding to the TRPG level information includes an index of the at least one TRPG and PH corresponding to an index of each TRPG Optionally, the PHR corresponding to the TRPG level information may further include parameter information such as P_{cmax,TRPGi}.

Step 205: The user equipment sends the PHR corresponding to the TRPG level information to the base station.

Specifically, the user equipment may send the PHR to the base station in a periodic reporting manner, or send the PHR to the base station in a condition-triggered reporting manner, or may send the PHR to the base station in a manner indicated by the base station. This is not limited in this embodiment of the present invention.

In this embodiment, the base station sends the power headroom report PHR level information to the user equipment, where the PHR level information includes the TRPG level information; the user equipment determines, based on the TRPG level information, the PHR corresponding to the TRPG level information; the user equipment sends the PHR corresponding to the TRPG level information to the base station; and the base station may learn PH of a TRPG based on the PHR, so that the base station schedules the user equipment in the TRPG In this way, the base station obtains PH of the UE at a TRPG level based on a scheduling requirement, and further performs proper scheduling on the UE based on a PHR.

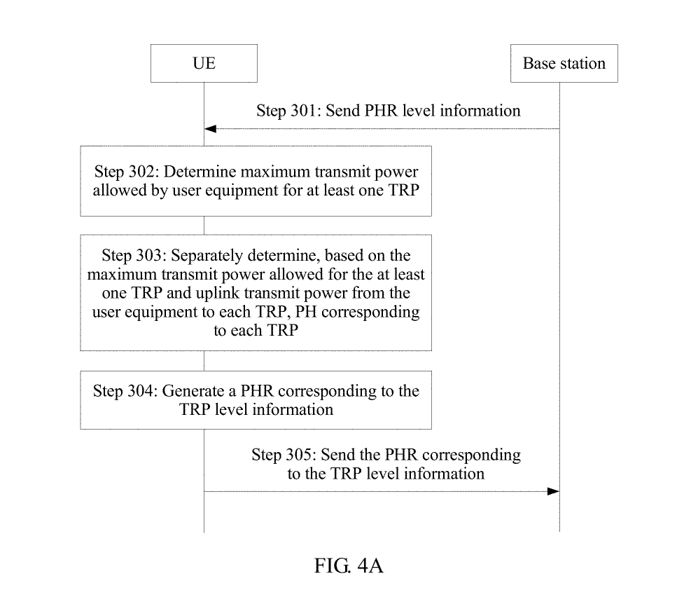

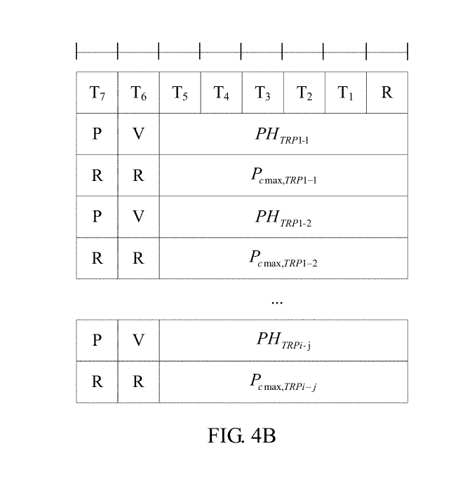

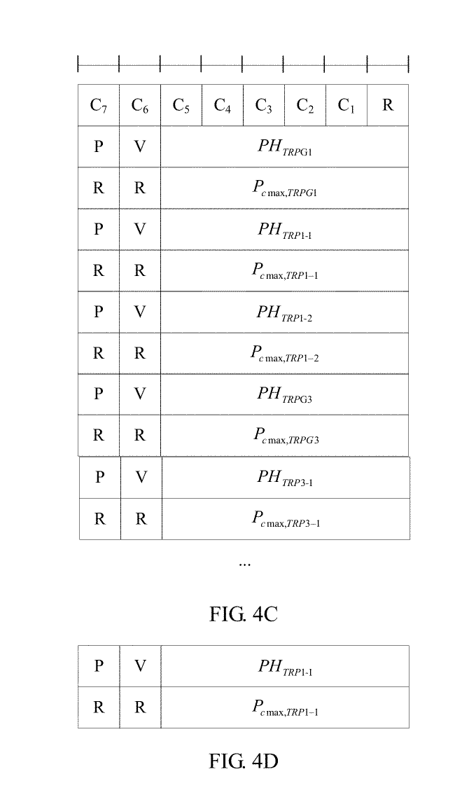

FIG. 4A is a flowchart of another power headroom report reporting method according to an embodiment of the present invention. FIG. 4B is a schematic diagram of a format of a MAC CE used by a PHR corresponding to TRP level information according to an embodiment of the present invention. FIG. 4C is a schematic diagram of another format of a MAC CE used by a PHR corresponding to TRP level information according to an embodiment of the present invention. FIG. 4D is a schematic diagram of still another format of a MAC CE used by a PHR corresponding to TRP level information according to another embodiment of the present invention. This embodiment describes in detail a power headroom report reporting method in which PHR level information includes TRP level information. As shown in FIG. 4A, the method in this embodiment may include the following steps.

Step 301: A base station sends power headroom report PHR level information to user equipment.

The user equipment receives the PHR level information sent by the base station.

For specific description of step 301, refer to step 101. When the PHR level information includes the TRP level information, the following step 302 to step 305 may be performed.

Step 302: The user equipment determines, based on the TRP level information, maximum transmit power allowed by the user equipment for at least one TRP.

Specifically, when the PHR level information includes the TRP level information, the user equipment determines the maximum transmit power allowed by the user equipment for one or more TRPs. The application scenario shown in FIG. 1 is further used as an example for description. The user equipment shown in FIG. 1 may send uplink data by using a TRP 1-1, a TRP 1-2, a TRP 2, and a TRP 3-1, and the user equipment determines, based on the TRP level information, maximum transmit power P_{cmax,TRPG1-1} allowed by the user equipment for the TRP 1-1, maximum transmit power P_{cmax,TRPG1-2} allowed by the user equipment for the TRP 1-2, maximum transmit power P_{cmax,TRPG2} allowed by the user equipment for the TRP 2, and maximum transmit power P_{cmax,TRPG3-1} allowed by the user equipment for the TRP 3-1.

The user equipment may further determine uplink transmit power from the user equipment to each TRP based on the TRP level information. Specifically, the application scenario shown in FIG. 1 is further used as an example for description. The user equipment determines uplink transmit power from the user equipment to the TRP 1-1, uplink transmit power from the user equipment to the TRP 1-2, uplink transmit power from the user equipment to the TRP 2, and uplink transmit power from the user equipment to the TRP 3-1.

Step 303: The user equipment separately determines, based on the maximum transmit power allowed for the at least one TRP and uplink transmit power from the user equipment to each TRP, PH corresponding to each TRP.

The uplink transmit power from the user equipment to each TRP is a sum of uplink transmit power of the user equipment on all beams included in each TRP.

A specific implementation of step 303 is that the user equipment determines the PH corresponding to each TRP in the following manner:

PH_{TRPi-j}=P_{cmax,TRPi-j}−Uplink transmit power from UE to a TRPi-j

In the foregoing formula, i is a positive integer, j is a positive integer, i may be specifically a sequence number of a TRPG and j may be specifically a sequence number of a TRP in a TRPG For example, P_{cmax,TRPGi-j}, may be P_{cmax,TRPG1-1} P_{cmax,TRPG1-2}, P_{cmax,TRPG3-1}, or the like. P_{cmax,TRPG1-1} is the maximum transmit power allowed by the UE for the TRP 1-1. It should be noted that, when there is only one TRP in a TRPG there may be no sequence number of j. Certainly, it may be understood that i-j may also be denoted as n, that is, one sequence number is used to uniquely represent one TRP. In this embodiment of the present invention, i-j is used as only an example for description. The uplink transmit power from the UE to TRPi-j in the foregoing formula specifically means a sum of transmit power of the UE on all beams in TRPi-j in a PHR reporting subframe. The TRP 1-2 shown in FIG. 1 is used as an example for description. The uplink transmit power from the UE to the TRP 1-2 is a sum of transmit power of the UE on a beam 2 and a beam 3. PH_{THRP1-2} is equal to P_{cmax,TRPG1-2} of the UE in the subframe minus the sum of transmit power of the UE on the beam 2 and the beam 3.

Step 304: The user equipment generates, based on the PH corresponding to each TRP, a PHR corresponding to the TRP level information.

The PHR corresponding to the TRP level information includes PH corresponding to the at least one TRP. Optionally, the PHR corresponding to the TRP level information may further include an index of each TRP. Optionally, the PHR corresponding to the TRP level information may further include parameter information such as P_{cmax,TRPGi-j}.

In an implementation, the PHR corresponding to the TRP level information may be specifically the MAC CE shown in FIG. 4B. As shown in FIG. 4B, the first row is used to carry an index of a TRP, and the second row to the (2n+1)^{th} row are used to carry PH and P_{cmax,TRPGi-j} that are corresponding to the index of the TRP. A size of the MAC CE is variable, and is specifically related to the PH corresponding to the index of the TRP. P_{cmax,TRPGi-j} may be carried or not carried. As shown in FIG. 4B, the second row carries P_{TRP1-1}, and the third row carries P_{cmax,TRPG1-1}. For example, as shown in FIG. 4B, T₁ may carry an index of the TRP 1-1, and T₂ may carry an index of the TRP 1-2.

In another implementation, the PHR corresponding to the TRP level information may be reported together with a cell-level PHR and/or a PHR corresponding to TRPG level information. Therefore, the PHR may be specifically the MAC CE shown in FIG. 4C. As shown in FIG. 4C, the first row is used to carry an index of a TRPG and an index of a TRP, and the second row to the (2n+1)^{t}h row are used to carry PH and P_{cmax,TRPGi} that are corresponding to the index of the TRPG and PH and P_{cmax,TRPGi-j}, that are corresponding to the index of the TRP. A size of the MAC CE is variable, and is specifically related to the PH corresponding to each of the index of the TRPG and the index of the TRP. P_{cmax,TRPGi} and P_{cmax,TRPGi-j} may be carried or not carried. As shown in FIG. 4C, the second row carries PH_{TRPG1}, the third row carries P_{cmax,TRPGi-j}, the fourth row carries PH-1, and the fifth row carries P_{cmax,TRPG1-1}. For example, as shown in FIG. 4C, C₁ may carry an index of a TRPG 1, and C₂ may carry an index of the TRP 1-1.

In still another possible implementation, the PHR corresponding to the TRP level information may be specifically the MAC CE shown in FIG. 4D. As shown in FIG. 4D, the MAC CE may carry no index of a TRP, only carries PH of a TRP, and optionally carries maximum transmit power allowed by the UE for a TRP. As shown in FIG. 4D, the first row carries PH_{TRP1-1}, and the second row carries P_{cmax,TRPG1-1}. The UE may send the MAC CE shown in FIG. 4D to the TRP 1-1, and the TRP 1-1 adds an index of the TRP 1-1 to the MAC CE, and send the MAC CE to the base station.

Step 305: The user equipment sends the PHR corresponding to the TRP level information to the base station.

Specifically, the user equipment may send the PHR to the base station in a periodic reporting manner, or send the PHR to the base station in a condition-triggered reporting manner, or may send the PHR to the base station in a manner indicated by the base station. This is not limited in this embodiment of the present invention.

In this embodiment, the base station sends the power headroom report PHR level information to the user equipment, where the PHR level information includes the TRP level information; the user equipment determines, based on the TRP level information, the PHR corresponding to the TRP level information; the user equipment sends the PHR corresponding to the TRP level information to the base station; and the base station may learn PH of a TRP based on the PHR, so that the base station schedules the user equipment on the TRP. In this way, the base station obtains PH of the UE at a TRP level based on a scheduling requirement, and further performs proper scheduling on the UE based on a PHR.

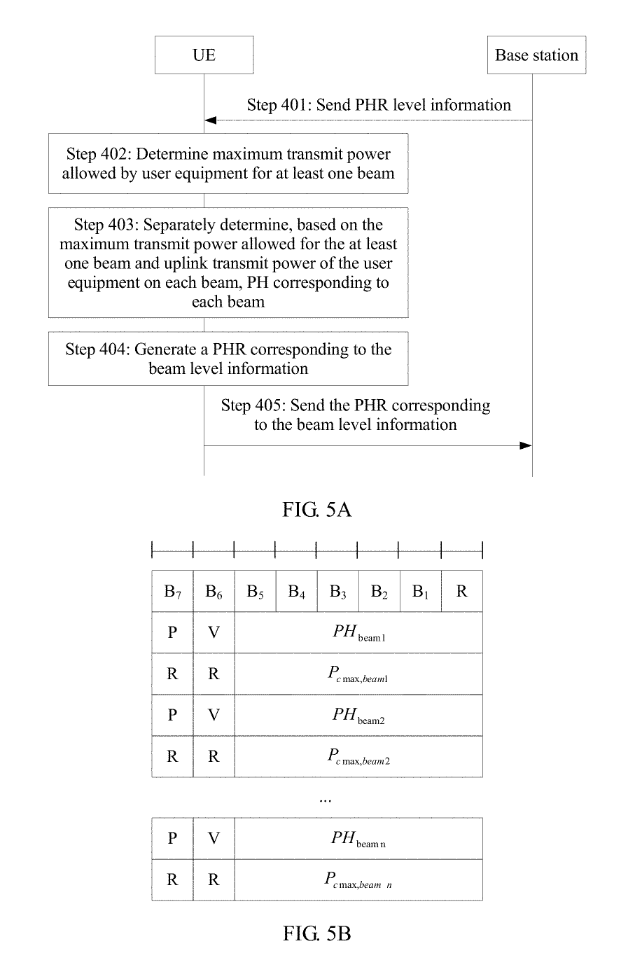

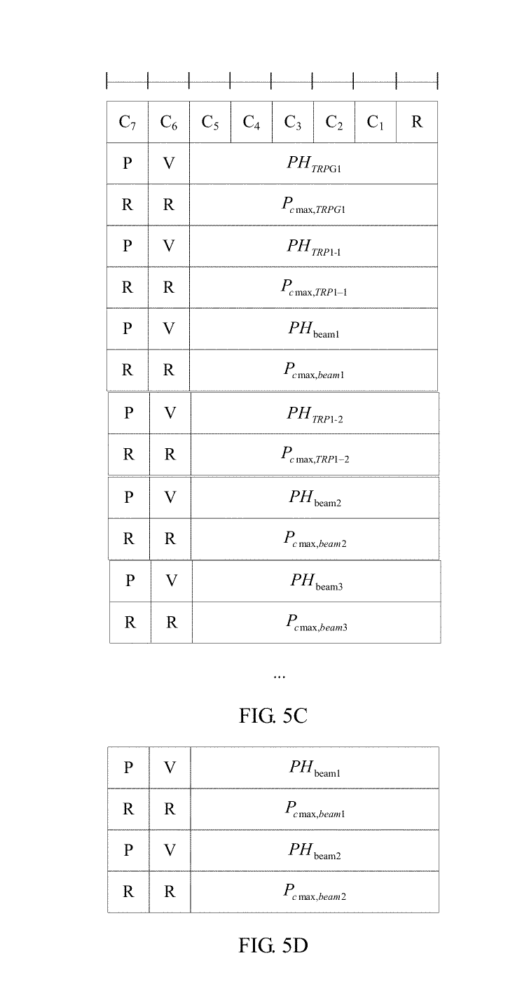

FIG. 5A is a flowchart of another power headroom report reporting method according to an embodiment of the present invention. FIG. 5B is a schematic diagram of a format of a MAC CE used by a PHR corresponding to beam level information according to an embodiment of the present invention. FIG. 5C is a schematic diagram of another format of a MAC CE used by a PHR corresponding to beam level information according to an embodiment of the present invention. FIG. 5D is a schematic diagram of still another format of a MAC CE used by a PHR corresponding to beam level information according to another embodiment of the present invention. This embodiment describes in detail a power headroom report reporting method in which PHR level information includes beam level information. As shown in FIG. 5A, the method in this embodiment may include the following steps.

Step 401: A base station sends power headroom report PHR level information to user equipment.

The user equipment receives the PHR level information sent by the base station.

For specific description of step 401, refer to step 101. When the PHR level information includes the beam level information, the following step 402 to step 405 may be performed.

Step 402: The user equipment determines, based on the beam level information, maximum transmit power allowed by the user equipment for at least one beam.

Specifically, when the PHR level information includes the beam level information, the user equipment determines the maximum transmit power allowed by the user equipment for one or more beams. The application scenario shown in FIG. 1 is further used as an example for description. The user equipment shown in FIG. 1 may send uplink data by using a beam 1, a beam 2, a beam 3, a beam 4, and a beam 5, and the user equipment determines, based on the beam level information, maximum transmit power P_{cmax,beam1} allowed by the user equipment for the beam 1, maximum transmit power P_{cmax,beam2} allowed by the user equipment for the beam 2, maximum transmit power P_{cmax,beam3} allowed by the user equipment for the beam 3, maximum transmit power P_{cmax,beam4} allowed by the user equipment for the beam 4, and maximum transmit power P_{cmax,beam5} allowed by the user equipment for the beam 5.

The user equipment may further determine transmit power of the user equipment on each beam based on the beam level information. Specifically, the application scenario shown in FIG. 1 is further used as an example for description. The user equipment determines transmit power of the user equipment on the beam 1, transmit power of the user equipment on the beam 2, transmit power of the user equipment on the beam 3, transmit power of the user equipment on the beam 4, and transmit power of the user equipment on the beam 5.

Step 403: The user equipment separately determines, based on the maximum transmit power allowed for the at least one beam and uplink transmit power of the user equipment on each beam, PH corresponding to each beam.

A specific implementation of step 403 is that the user equipment determines the PH corresponding to each beam in the following manner:

PH_{beam n}=P_{cmax,beam n}−Uplink transmit power of UE on a beam n

In the foregoing formula, n is a positive integer. For example, P_{cmax,beam n} may be P_{cmax,beam1}, P_{cmax,beam2}, P_{cmax,beam3}, or the like. P_{cmax,beam1} is the maximum transmit power allowed by the UE on the beam 1. The uplink transmit power of the UE on the beam n in the foregoing formula is specifically transmit power of the UE on the beam 1 in a PHR reporting subframe. The beam 1 shown in FIG. 1 is used as an example for description. PH_{beam1} is equal to P_{cmax,beam1} of the UE minus the transmit power of the UE on the beam 1.

Step 404: The user equipment generates, based on the PH corresponding to each beam, a PHR corresponding to the beam level information.

The PHR corresponding to the beam level information includes PH corresponding to the at least one beam. Optionally, the PHR corresponding to the beam level information may further include an index of each beam. Optionally, the PHR corresponding to the beam level information may further include parameter information such as P_{cmax,beam n}.

In an implementation, the PHR corresponding to the beam level information may be specifically the MAC CE shown in FIG. 5B. As shown in FIG. 5B, the first row is used to carry an index of a beam, and the second row to the (2n+1)^{th} row are used to carry PH and P_{cmax,beam n} that are corresponding to the index of the beam. A size of the MAC CE is variable, and is specifically related to the PH corresponding to the index of the beam. P_{cmax,beam n} may be carried or not carried. As shown in FIG. 5B, the second row carries PH_{beam1}, and the third row carries P_{cmax,beam1}. For example, as shown in FIG. 5B, B₁ may carry an index of the beam 1, and B₂ may carry an index of the beam 2.

In another implementation, the PHR corresponding to the beam level information may be reported in any combination with a cell-level PHR, a PHR corresponding to TRPG level information, and a PHR corresponding to TRP level information. Therefore, the PHR may be specifically the MAC CE shown in FIG. 5C. As shown in FIG. 5C, the first row is used to carry an index of a beam, an index of a TRPG and an index of a TRP, and the second row to the (2n+1)^{th} row are used to carry PH and P_{cmax,beam n} that are corresponding to the index of the beam, PH and P_{cmax,TRPGi} that are corresponding to the index of the TRPG, and PH and P_{cmax,TRPi-j} that are corresponding to the index of the TRP. A size of the MAC CE is variable, and is specifically related to the PH corresponding to each of the index of the beam, the index of the TRPG and the index of the TRP. P_{cmax,beam n}, P_{cmax,TRPi}, and P_{cmax,TRPi-j} may be carried or not carried. As shown in FIG. 5C, the second row carries PH_{TRPG1}, the third row carries P_{cmax,TRPG1}, the fourth row carries P_{TRP1-1}, the fifth row carries P_{cmax,TRP1-1}, the sixth row carries PH_{beam1}, and the seventh row carries P_{cmax,beam 1}. For example, as shown in FIG. 5C, C₁ may carry an index of a TRPG 1, and C₂ may carry an index of a TRP 1-1.

In still another possible implementation, the PHR corresponding to the beam level information may be specifically the MAC CE shown in FIG. 5D. As shown in FIG. 5D, the MAC CE may carry no index of a beam, only carries PH of a beam, and optionally carries maximum transmit power allowed by the UE for a beam. As shown in FIG. 5D, the first row carries PH_{beam1}, and the second row carries P_{cmax,beam1}. The UE may send the MAC CE shown in FIG. 5D to the TRP 1-1, and the TRP 1-1 adds an index of the TRP 1-1 to the MAC CE, and sends the MAC CE to the base station. The application scenario shown in FIG. 1 is further used as an example for description. A PHR of the UE for the beam 1 may be reported to the TRP 1-1, and a PHR for the beam 2 may be reported to a TRP 1-2. When the TRP 1-1 and the TRP 1-2 report the PHRs to a scheduler of the gNB 1, the PHRs respectively carry the index of the beam 1 and the index of the beam 2. The scheduler performs unified processing based on the index of the TRP 1-1 and the index of the beam 1, the index of the TRP 1-2 and the index of the beam 2, and the like.

In yet another possible implementation, a PHR may also be sent by using the MAC CE shown in FIG. 5D. Unlike the foregoing still another possible implementation, one MAC CE carries a PHR of one beam, the PHR of the beam is sent to a corresponding TRP or scheduler by using the beam, the TRP that receives the PHR reports the PHR to the scheduler, and the scheduler performs unified processing based on a beam index (or identifier). The application scenario shown in FIG. 1 is further used as an example for description. A PHR of the UE for the beam 2 may be sent on the beam 2 to a TRP 1-2, and a PHR of the UE for the beam 3 may be sent on the beam 3 to the TRP 1-2. The TRP 1-2 obtains a beam index based on a beam on which a PHR is received, and then sends the beam index and the PHR of the beam to the scheduler. The scheduler performs unified processing based on the beam index or the like.

Step 405: The user equipment sends the PHR corresponding to the beam level information to the base station.

Specifically, the user equipment may send the PHR to the base station in a periodic reporting manner, or send the PHR to the base station in a condition-triggered reporting manner, or may send the PHR to the base station in a manner indicated by the base station. This is not limited in this embodiment of the present invention.

In this embodiment, the base station sends the power headroom report PHR level information to the user equipment, where the PHR level information includes the beam level information; the user equipment determines, based on the beam level information, the PHR corresponding to the beam level information; the user equipment sends the PHR corresponding to the beam level information to the base station; and the base station may learn PH of a beam based on the PHR, so that the base station schedules the user equipment on the beam. In this way, the base station obtains PH of the UE at a beam level based on a scheduling requirement, and further performs proper scheduling on the UE based on a PHR.

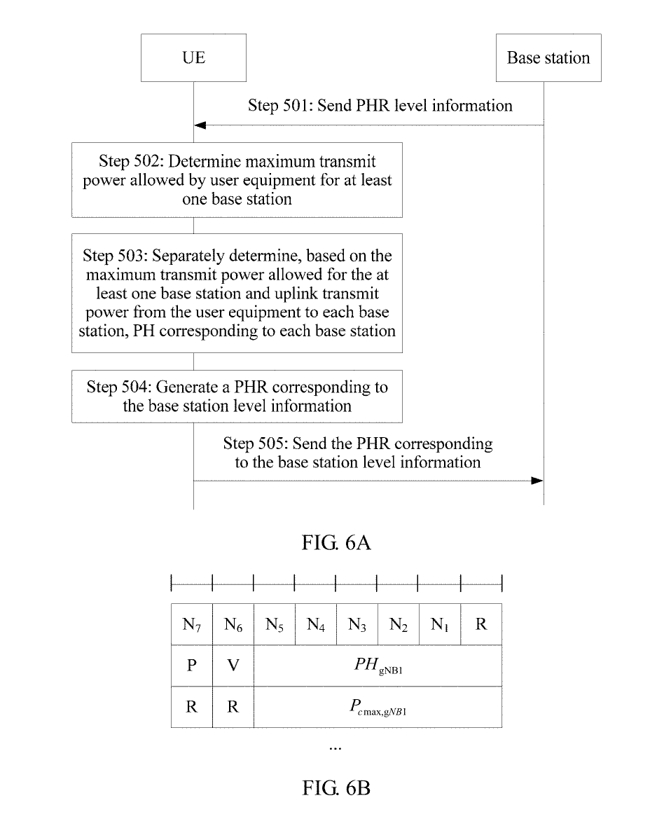

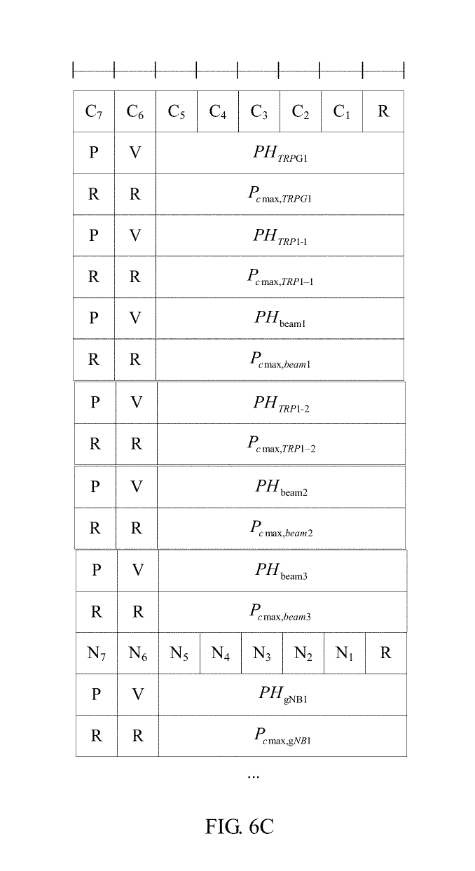

FIG. 6A is a flowchart of another power headroom report reporting method according to an embodiment of the present invention. FIG. 6B is a schematic diagram of a format of a MAC CE used by a PHR corresponding to base station level information according to an embodiment of the present invention. FIG. 6C is a schematic diagram of another format of a MAC CE used by a PHR corresponding to base station level information according to an embodiment of the present invention. This embodiment describes in detail a power headroom report reporting method in which PHR level information includes base station level information. As shown in FIG. 6A, the method in this embodiment may include the following steps.

Step 501: A base station sends power headroom report PHR level information to user equipment.

The user equipment receives the PHR level information sent by the base station.

For specific description of step 501, refer to step 101. When the PHR level information includes the base station level information, the following step 502 to step 505 may be performed.

Step 502: The user equipment determines, based on the base station level information, maximum transmit power allowed by the user equipment for at least one base station.

Specifically, when the PHR level information includes the base station level information, the user equipment determines the maximum transmit power allowed by the user equipment for one or more base stations. The application scenario shown in FIG. 1 is further used as an example for description. The user equipment shown in FIG. 1 may send uplink data to a gNB 1 and a gNB 2, and the user equipment determines, based on the base station level information, maximum transmit power P_{cmax,gNB1} allowed by the user equipment for the gNB 1, and maximum transmit power P_{cmax,gNB2} allowed by the user equipment for the gNB 2.

The user equipment may further determine uplink transmit power from the user equipment to each base station based on the base station level information. Specifically, the application scenario shown in FIG. 1 is further used as an example for description. The user equipment determines uplink transmit power from the user equipment to the gNB 1 and uplink transmit power from the user equipment to the gNB 2. The uplink transmit power from the user equipment to each base station is a sum of uplink transmit power of the user equipment in all cells included in each base station.

Step 503: The user equipment separately determines, based on the maximum transmit power allowed for the at least one base station and uplink transmit power from the user equipment to each base station, PH corresponding to each base station.

A specific implementation of step 503 is that the user equipment determines the PH corresponding to each base station in the following manner:

PH_{gNB m}=P_{cmac,gNB m}−Uplink transmit power from UE to a gNB m

In the foregoing formula, m is any positive integer. For example, P_{cmax,gNB m} may be P_{cmax,gNB1}, P_{cmax,gNB2}, or the like. P_{cmax,gNB1} is the maximum transmit power allowed by the UE for the gNB 1. The uplink transmit power from the UE to the gNB m in the foregoing formula is specifically a sum of transmit power of the UE on all beams in TRPs of all cells in the gNB 1 in a PHR reporting subframe. The gNB 1 shown in FIG. 1 is used as an example for description. PH_{gNB1} is equal to P_{cmax,gNB1} of the UE minus a sum of transmit power of the UE on a beam 1, a beam 2, a beam 3, and a beam 4.

Step 504: The user equipment generates, based on the PH corresponding to each base station, a PHR corresponding to the base station level information.

The PHR corresponding to the base station level information includes an index of the at least one base station and PH corresponding to an index of each base station. Optionally, the PHR corresponding to the base station level information may further include parameter information such as P_{cmax,gNB m}.

In an implementation, the PHR corresponding to the base station level information may be specifically the MAC CE shown in FIG. 6B. As shown in FIG. 6B, the first row is used to carry an index of the gNB 1, and the second row to the (2n+1)^{th} row are used to carry PH and P_{cmax,gNB m} that are corresponding to the index of the gNB 1. A size of the MAC CE is variable, and is specifically related to the PH corresponding to the index of the gNB. P_{cmax,gNB m} may be carried or not carried. As shown in FIG. 6B, the second row carries PH_{gNB1}, and the third row carries P_{cmax,gNB1}. For example, N₁ shown in FIG. 6B may carry the index of the gNB 1.

In another implementation, the PHR corresponding to the base station level information may be reported in any combination with a cell-level PHR, a PHR corresponding to TRPG level information, a PHR corresponding to TRP level information, and a PHR corresponding to beam level information. Therefore, the PHR may be specifically the MAC CE shown in FIG. 6C. As shown in FIG. 6C, the first row is used to carry an index of a beam, an index of a TRPG and an index of a TRP, and the second row to the (2n+1)^{th} row are used to carry PH and P_{cmax,beam n} that are corresponding to the index of the beam, PH and P_{cmax,TRPGi} that are corresponding to the index of the TRPG and PH and P_{cmax,TRPi-j}, that are corresponding to the index of the TRP. An index of a base station and PH and P_{cmax,gNB m} that are corresponding to the index of the base station are carried below the foregoing information. A size of the MAC CE is variable, and is specifically related to the PH corresponding to each of the index of the base station, the index of the beam, the index of the TRPG and the index of the TRP. P_{cmax,beam n}, P_{cmax,TRPGi}, P_{maxGRPGi} and P_{cmax,gNB m} may be carried or not carried. As shown in FIG. 6C, the second row carries P_{TRPG1}, and the third row carries P_{cmax,TRPG1}. For example, C₁ shown in FIG. 6C may carry an index of a TRPG 1. As shown in FIG. 6C, N₁ may carry the index of the gNB 1, and a lower part of a row corresponding to the index of the gNB 1 may carry PH_{gNB1}, P_{cmax,gNB1} and the like.

It should be noted that, the format of the foregoing PHR is only an example for illustration, and there are a plurality of options thereof. Examples are not enumerated herein.

Step 505: The user equipment sends the PHR corresponding to the base station level information to the base station.

Specifically, the user equipment may send the PHR to the base station in a periodic reporting manner, or send the PHR to the base station in a condition-triggered reporting manner, or may send the PHR to the base station in a manner indicated by the base station. This is not limited in this embodiment of the present invention.

In this embodiment, the base station sends the power headroom report PHR level information to the user equipment, where the PHR level information includes the base station level information; the user equipment determines, based on the base station level information, the PHR corresponding to the base station level information; the user equipment sends the PHR corresponding to the base station level information to the base station; and the base station may learn PH of a base station based on the PHR, so that the base station schedules the user equipment on the base station. In this way, the base station obtains PH of the UE at a base station level based on a scheduling requirement, and further performs proper scheduling on the UE based on a PHR. Compared with a PHR at a TRPG level, a TRP level, or a beam level, the PHR at the base station level can effectively reduce air interface signaling overheads.

It can be learned that, the base station in this embodiment of the present invention may flexibly send the PHR level information to the user equipment based on a requirement, so that the user equipment reports the PHR based on the PHR level information, and a PHR reporting manner is more flexible and effective.

It should be noted that the UE does not perform any sending on a beam and/or a TRP in a PHR sending subframe, or the UE does not send a PUCCH and/or a PUSCH on a beam and/or a TRP in a PHR sending subframe, and the base station may also request a PHR from the UE by using an implementation of the foregoing method embodiment. When the UE performs a multi-connection operation, the base station may also instruct the UE to report a PHR at any level of the UE for another serving base station.

In addition, the PHR reporting method in the embodiments of the present invention may also be applied to communications technologies such as a wireless local area network.

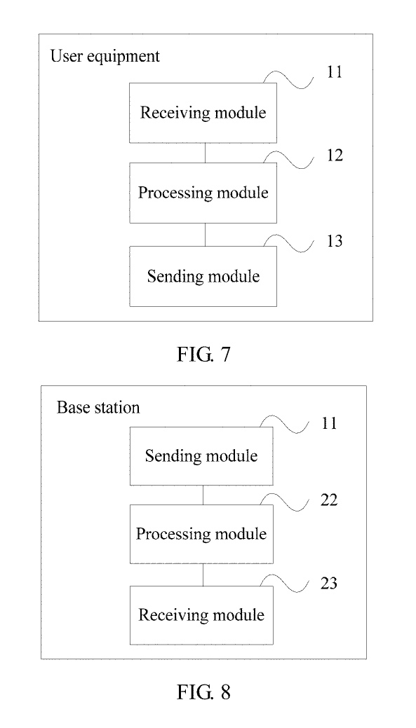

FIG. 7 is a schematic structural diagram of user equipment according to an embodiment of the present invention. As shown in FIG. 7, the apparatus in this embodiment may include a receiving module 11, a processing module 12, and a sending module 13. The receiving module 11 is configured to receive power headroom report PHR level information sent by a base station, the processing module 12 is configured to determine, based on the PHR level information, a PHR corresponding to the PHR level information, and the sending module 13 is configured to send the PHR corresponding to the PHR level information to the base station.

Optionally, the PHR level information includes any one or a combination of transmission and reception point group TRPG level information, transmission and reception point TRP level information, beam level information, and base station level information. The processing module 12 is specifically configured to determine, based on the PHR level information, a PHR corresponding to each piece of level information.

Optionally, if the PHR level information includes the TRPG level information, the processing module 12 is specifically configured to: determine, based on the TRPG level information, maximum transmit power allowed by the user equipment for at least one TRPG; separately determine, based on the maximum transmit power allowed for the at least one TRPG and uplink transmit power from the user equipment to each TRPG PH corresponding to each TRPG; and generate, based on the PH corresponding to each TRPG a PHR corresponding to the TRPG level information; where the uplink transmit power from the user equipment to each TRPG is a sum of uplink transmit power of the user equipment at all TRPs included in each TRPG

Optionally, the sending module 13 is specifically configured to send the PHR corresponding to the TRPG level information to the base station. The PHR corresponding to the TRPG level information includes an index of the at least one TRPG and PH corresponding to an index of each TRPG

Optionally, if the PHR level information includes the TRP level information, the processing module 12 is configured to: determine, based on the TRP level information, maximum transmit power allowed by the user equipment for at least one TRP; separately determine, based on the maximum transmit power allowed for the at least one TRP and uplink transmit power from the user equipment to each TRP, PH corresponding to each TRP; and generate, based on the PH corresponding to each TRP, a PHR corresponding to the TRP level information; where the uplink transmit power from the user equipment to each TRP is a sum of uplink transmit power of the user equipment on all beams included in each TRP.

Optionally, the sending module 13 is specifically configured to send the PHR corresponding to the TRP level information to the base station. The PHR corresponding to the TRP level information includes PH corresponding to the at least one TRP

Optionally, if the PHR level information includes the beam level information, the processing module 12 is specifically configured to: determine, based on the beam level information, maximum transmit power allowed by the user equipment for at least one beam; separately determine, based on the maximum transmit power allowed for the at least one beam and uplink transmit power of the user equipment on each beam, PH corresponding to each beam; and generate, based on the PH corresponding to each beam, a PHR corresponding to the beam level information.

Optionally, the sending module 13 is specifically configured to send the PHR corresponding to the beam level information to the base station. The PHR corresponding to the beam level information includes PH corresponding to the at least one beam.

Optionally, if the PHR level information includes the base station level information, the processing module 12 is specifically configured to: determine, based on the base station level information, maximum transmit power allowed by the user equipment for at least one base station; separately determine, based on the maximum transmit power allowed for the at least one base station and uplink transmit power from the user equipment to each base station, PH corresponding to each base station; and generate, based on the PH corresponding to each base station, a PHR corresponding to the base station level information; where the uplink transmit power from the user equipment to each base station is a sum of uplink transmit power of the user equipment in all cells included in each base station.

Optionally, the sending module 13 is specifically configured to send the PHR corresponding to the base station level information to the base station. The PHR corresponding to the base station level information includes an index of the at least one base station and PH corresponding to an index of each base station.

Optionally, the apparatus in this embodiment of the present invention may further include a storage module, where the storage module is configured to store program code and data of the user equipment.

The apparatus in this embodiment may be configured to perform the technical solution of the foregoing method embodiment. The implementation principles and technical effects are similar, and are not further described herein.

FIG. 8 is a schematic structural diagram of a base station according to an embodiment of the present invention. As shown in FIG. 8, the apparatus in this embodiment may include a sending module 21, a processing module 22, and a receiving module 23. The sending module 21 is configured to send power headroom report PHR level information generated by the processing module 22 to user equipment, where the PHR level information is used to instruct the user equipment to determine, based on the PHR level information, a PHR corresponding to the PHR level information, and the receiving module 23 is configured to receive the PHR that is corresponding to the PHR level information and that is sent by the user equipment.

Optionally, the PHR level information includes any one or a combination of transmission and reception point group TRPG level information, transmission and reception point TRP level information, beam level information, and base station level information. The receiving module 23 is specifically configured to receive a PHR that is corresponding to each piece of level information and that is sent by the user equipment.

Optionally, that the sending module 21 is configured to send power headroom report PHR level information generated by the processing module 22 to user equipment specifically includes: sending radio resource control signaling generated by the processing module 22 to the user equipment, where the radio resource control signaling includes the PHR level information; or sending a Media Access Control MAC control information element generated by the processing module 22 to the user equipment, where the MAC control information element includes the PHR level information.

Optionally, the apparatus in this embodiment of the present invention may further include a storage module, where the storage module is configured to store program code and data of the base station.

The apparatus in this embodiment may be configured to perform the technical solution of the foregoing method embodiment. The implementation principles and technical effects are similar, and are not further described herein.

For an interaction process between the foregoing apparatuses and another communications network element, refer to the description of the foregoing method embodiment. For beneficial effects of the interaction process, refer to the beneficial effects brought by the foregoing method embodiment, and details are not described herein again.

It should be noted that the receiving module 11 in the embodiments of the present invention may be corresponding to a receiver in user equipment, or may be corresponding to a transceiver in user equipment. The sending module 13 may be corresponding to a transmitter in the user equipment, or may be corresponding to a transceiver in the user equipment. The processing module 12 may be corresponding to a processor in the user equipment. The processor described herein may be a central processing unit (Central Processing Unit, CPU), or an application-specific integrated circuit (Application Specific Integrated Circuit, ASIC), or one or more integrated circuits for implementing the embodiments of the present invention. The user equipment may further include a memory, and the memory is configured to store instruction code. The processor invokes the instruction code in the memory, to control the receiving module 11 and the sending module 13 in the embodiments of the present invention to perform the foregoing operations.

The sending module 21 in the embodiments of the present invention may be corresponding to a transmitter in a base station, or may be corresponding to a transceiver in a base station. The receiving module 23 may be corresponding to a receiver in the base station, or may be corresponding to a transceiver in the base station. The processing module 22 may be corresponding to a processor in the base station. The processor herein may be a CPU, an ASIC, or one or more integrated circuits for implementing the embodiments of the present invention. The base station may further include a memory, and the memory is configured to store instruction code. The processor invokes the instruction code in the memory, to control the sending module 21 and the receiving module 23 in the embodiments of the present invention to perform the foregoing operations.

When at least a part of functions of the power headroom report reporting method in the embodiments of the present invention are implemented by using software, an embodiment of the present invention further provides a computer readable storage medium, where the computer readable storage medium is configured to store a computer software instruction used by the foregoing user equipment, and when the computer software instruction runs on a computer, the computer can perform various possible power headroom report reporting methods in the foregoing method embodiments. When the computer executable instruction is loaded and executed on the computer, the procedure or functions according to the embodiments of the present invention are all or partially generated. The computer instruction may be stored in the computer readable storage medium, or transmitted from one computer readable storage medium to another computer readable storage medium, and the transmission may be transmitted to another website site, computer, server, or data center in a wireless (for example, cellular communications, infrared, short-range wireless, or microwave) manner. The computer readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a digital versatile disc (DVD)), a semiconductor medium (for example, a Solid State Disk (SSD)), or the like.

When at least a part of functions of the power headroom report reporting method in the embodiments of the present invention are implemented by using software, an embodiment of the present invention further provides a computer readable storage medium, where the computer readable storage medium is configured to store a computer software instruction used by the foregoing base station, and when the computer software instruction runs on a computer, the computer can perform various possible power headroom report reporting methods in the foregoing method embodiments. When the computer executable instruction is loaded and executed on the computer, the procedure or functions according to the embodiments of the present invention are all or partially generated. The computer instruction may be stored in the computer readable storage medium, or transmitted from one computer readable storage medium to another computer readable storage medium, and the transmission may be transmitted to another website site, computer, server, or data center in a wireless (for example, cellular communications, infrared, short-range wireless, or microwave) manner. The computer readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), or a semiconductor medium (for example, an SSD).

In addition, an embodiment of the present invention further provides a computer program product that includes an instruction, that is, a software product. When the software product runs on a computer, the computer can perform various possible power headroom report reporting methods in the foregoing method embodiments. Implementation principles and technical effects thereof are similar, and details are not described herein again.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A power headroom report reporting method, comprising:
receiving, by user equipment, power headroom report PHR level information sent by a base station;
determining, by the user equipment based on the PHR level information, a PHR corresponding to the PHR level information; and
sending, by the user equipment, the PHR corresponding to the PHR level information to the base station.

2. The method according to claim 1, wherein the PHR level information comprises any one or a combination of transmission and reception point group TRPG level information, transmission and reception point TRP level information, beam level information, and base station level information; and
the determining, by the user equipment based on the PHR level information, a PHR corresponding to the PHR level information comprises:
determining, by the user equipment based on the PHR level information, a PHR corresponding to each piece of level information.

3. The method according to claim 2, wherein if the PHR level information comprises the TRPG level information, the determining, by the user equipment based on the PHR level information, a PHR corresponding to each piece of level information comprises:
determining, by the user equipment based on the TRPG level information, maximum transmit power allowed by the user equipment for at least one TRPG;
separately determining, by the user equipment based on the maximum transmit power allowed for the at least one TRPG and uplink transmit power from the user equipment to each TRPG, PH corresponding to each TRPG; and
generating, by the user equipment based on the PH corresponding to each TRPG, a PHR corresponding to the TRPG level information; wherein
the uplink transmit power from the user equipment to each TRPG is a sum of uplink transmit power of the user equipment at all TRPs included in each TRPG.

4. The method according to claim 3, wherein the sending, by the user equipment, the PHR corresponding to the PHR level information to the base station comprises:
sending, by the user equipment, the PHR corresponding to the TRPG level information to the base station, wherein
the PHR corresponding to the TRPG level information comprises an index of the at least one TRPG and PH corresponding to an index of each TRPG.

5. The method according to claim 2, wherein if the PHR level information comprises the TRP level information, the determining, by the user equipment based on the PHR level information, a PHR corresponding to each piece of level information comprises:
determining, by the user equipment based on the TRP level information, maximum transmit power allowed by the user equipment for at least one TRP;
separately determining, by the user equipment based on the maximum transmit power allowed for the at least one TRP and uplink transmit power from the user equipment to each TRP, PH corresponding to each TRP; and
generating, by the user equipment based on the PH corresponding to each TRP, a PHR corresponding to the TRP level information; wherein
the uplink transmit power from the user equipment to each TRP is a sum of uplink transmit power of the user equipment on all beams included in each TRP.

6. The method according to claim 5, wherein the sending, by the user equipment, the PHR corresponding to the PHR level information to the base station comprises:
sending, by the user equipment, the PHR corresponding to the TRP level information to the base station, wherein
the PHR corresponding to the TRP level information comprises PH corresponding to the at least one TRP.

7. The method according to claim 2, wherein if the PHR level information comprises the beam level information, the determining, by the user equipment based on the PHR level information, a PHR corresponding to each piece of level information comprises:
determining, by the user equipment based on the beam level information, maximum transmit power allowed by the user equipment for at least one beam;
separately determining, by the user equipment based on the maximum transmit power allowed for the at least one beam and uplink transmit power of the user equipment on each beam, PH corresponding to each beam; and
generating, by the user equipment based on the PH corresponding to each beam, a PHR corresponding to the beam level information.

8. The method according to claim 7, wherein the sending, by the user equipment, the PHR corresponding to the PHR level information to the base station comprises:
sending, by the user equipment, the PHR corresponding to the beam level information to the base station, wherein
the PHR corresponding to the beam level information comprises PH corresponding to the at least one beam.

9. The method according to claim 2, wherein if the PHR level information comprises the base station level information, the determining, by the user equipment based on the PHR level information, a PHR corresponding to each piece of level information comprises:
determining, by the user equipment based on the base station level information, maximum transmit power allowed by the user equipment for at least one base station;
separately determining, by the user equipment based on the maximum transmit power allowed for the at least one base station and uplink transmit power from the user equipment to each base station, PH corresponding to each base station; and
generating, by the user equipment based on the PH corresponding to each base station, a PHR corresponding to the base station level information; wherein
the uplink transmit power from the user equipment to each base station is a sum of uplink transmit power of the user equipment in all cells included in each base station.

10. The method according to claim 9, wherein the sending, by the user equipment, the PHR corresponding to the PHR level information to the base station comprises:
sending, by the user equipment, a PHR corresponding to the base station level information to the base station, wherein
the PHR corresponding to the base station level information comprises an index of the at least one base station and PH corresponding to an index of each base station.

11. A power headroom report reporting method, comprising:
sending, by a base station, power headroom report PHR level information to user equipment, wherein the PHR level information is used to instruct the user equipment to determine, based on the PHR level information, a PHR corresponding to the PHR level information; and
receiving, by the base station, the PHR that is corresponding to the PHR level information and that is sent by the user equipment.

12. The method according to claim 11, wherein the PHR level information comprises any one or a combination of transmission and reception point group TRPG level information, transmission and reception point TRP level information, beam level information, and base station level information; and
the receiving, by the base station, the PHR that is corresponding to the PHR level information and that is sent by the user equipment comprises:
receiving, by the base station, a PHR that is corresponding to each piece of level information and that is sent by the user equipment.

13. The method according to claim 11, wherein the sending, by a base station, power headroom report PHR level information to user equipment comprises:
sending, by the base station, radio resource control signaling to the user equipment, wherein the radio resource control signaling comprises the PHR level information; or
sending, by the base station, a Media Access Control MAC control information element to the user equipment, wherein the MAC control information element comprises the PHR level information.

14. User equipment, comprising:
a receiving module, configured to receive power headroom report PHR level information sent by a base station;
a processing module, configured to determine, based on the PHR level information, a PHR corresponding to the PHR level information; and
a sending module, configured to send the PHR corresponding to the PHR level information to the base station.

15. The user equipment according to claim 14, wherein the PHR level information comprises any one or a combination of transmission and reception point group TRPG level information, transmission and reception point TRP level information, beam level information, and base station level information; and
the processing module is specifically configured to:
determine, based on the PHR level information, a PHR corresponding to each piece of level information.

16. The user equipment according to claim 15, wherein if the PHR level information comprises the TRPG level information, the processing module is specifically configured to:
determine, based on the TRPG level information, maximum transmit power allowed by the user equipment for at least one TRPG;
separately determine, based on the maximum transmit power allowed for the at least one TRPG and uplink transmit power from the user equipment to each TRPG, PH corresponding to each TRPG; and
generate, based on the PH corresponding to each TRPG, a PHR corresponding to the TRPG level information; wherein
the uplink transmit power from the user equipment to each TRPG is a sum of uplink transmit power of the user equipment at all TRPs included in each TRPG.

17. The user equipment according to claim 16, wherein the sending module is specifically configured to:
send the PHR corresponding to the TRPG level information to the base station, wherein
the PHR corresponding to the TRPG level information comprises an index of the at least one TRPG and PH corresponding to an index of each TRPG.

18. The user equipment according to claim 1, wherein if the PHR level information comprises the TRP level information, the processing module is configured to:
determine, based on the TRP level information, maximum transmit power allowed by the user equipment for at least one TRP;
separately determine, based on the maximum transmit power allowed for the at least one TRP and uplink transmit power from the user equipment to each TRP, PH corresponding to each TRP; and
generate, based on the PH corresponding to each TRP, a PHR corresponding to the TRP level information; wherein
the uplink transmit power from the user equipment to each TRP is a sum of uplink transmit power of the user equipment on all beams included in each TRP.

19. The user equipment according to claim 18, wherein the sending module is specifically configured to:
send the PHR corresponding to the TRP level information to the base station, wherein
the PHR corresponding to the TRP level information comprises PH corresponding to the at least one TRP.

20. The user equipment according to claim 15, wherein if the PHR level information comprises the beam level information, the processing module is specifically configured to:
determine, based on the beam level information, maximum transmit power allowed by the user equipment for at least one beam;
separately determine, based on the maximum transmit power allowed for the at least one beam and uplink transmit power of the user equipment on each beam, PH corresponding to each beam; and
generate, based on the PH corresponding to each beam, a PHR corresponding to the beam level information.

21-26. (canceled)
